(19) United States
(12) Patent Application Publication
(10) Pub. No.: US 2014/0216641 A1
(43) Pub. Date: Aug. 7, 2014

(54) Indexing Laminating System

(71) Applicant: Douglas M. Canfield, Cold Spring, NY (US)

(72) Inventor: Douglas M. Canfield, Cold Spring, NY (US)

(21) Appl. No.: 13/759,815

(22) Filed: Feb. 5, 2013

(51) Int. Cl. B32B 37/06

(52) U.S. Cl. CPC B32B 37/06
USPC 156/272.2; 156/380.9

(57) ABSTRACT

A system for laminating glass having an infrared heating module that includes at least two heating zones for heating a laminated material under vacuum where the two heating zones heat different section of a glass laminate. The system has a convection heating module that includes a heating coil that heats the glass laminate at atmospheric pressure and a cooling module. A system for laminating glass having at least one infrared heating unit, the at least one infrared heating unit arranged to provide three concentric heating zones for heating a laminated material, the three concentric heating zones heating different sections of the laminated material, and operation of the first heating module promotes the removal of air and moisture from the laminating glass.

### FIELD OF THE INVENTION

The present invention relates to a system and method for laminating glass using a conveyor system with an assembly that includes infrared heating units.

### BACKGROUND OF THE INVENTION

Glass lamination systems are known in the art. Prior glass lamination systems include U.S. Pat. No. 7,992,613 Damm et al.; U.S. Pat. No. 7,779,884 Damm et al.; 2010/0051195 Damm; 2010/0018646 Metzger et al.; 2011/0023733 Damm; 2009/0294036 Metzger et al.; 2010/0288442 Damm; 2008/0295956 Damm et al.; 2010/0282417 Damm et al.; 2008/0053609 Renz; U.S. Pat. No. 8,122,929 Zahnd et al.; 2011/0119898 Blanchet et al.; 2012/0073746 Zahnd et al.; U.S. Pat. No. 7,624,780 Stevens; U.S. Pat. No. 4,450,033 Little; U.S. Pat. No. 4,421,589 Armini et al.; U.S. Pat. No. 7,726,375 Kasahara et al.; 2009/0242137 Ishikawa et al.; U.S. Pat. No. 6,481,482 Shimotomai; U.S. Pat. No. 6,367,530 Shimotomai; U.S. Pat. No. 8,028,735 Chikaki; 2008/0041531 Chikaki; U.S. Pat. No. 7,699,085 Chikaki; 2008/0041528 Chikaki; U.S. Pat. No. 7,704,342 Bourcier et al.; 2008/0066857 Makizono; U.S. Pat. No. 4,421,589 Armini et al.; U.S. Pat. No. 4,450,033 Little; U.S. Pat. No. 7,476,284 Sklyarevich et al.; 2010/0101646 A1 Cadwallader et al.; U.S. Pat. No. 6,342,116 Balduin et al.; 2009/0126859 A1 Cadwallader et al.; 2001/0247754 Canfield; 2007/0034317 A1 Sklyarevich et al.; and 2008/0066857 Makizono.

Prior art glass lamination systems suffer from various deficiencies and problems, as these systems typically are not efficient in heating large pieces of glass laminate. These systems typically operate via convection heating, i.e., heating the glass laminate in an oven. However, such convection systems have difficulty in heating large pieces of glass as large pieces of glass do not typically fit in a convection oven.

Some systems known in the art provide for infrared heating. U.S. Patent Publication No. 2008/0066857 Makizono discloses a preheater that may be an infrared heater. U.S. Pat. No. 7,476,284 Sklyarevich et al. discloses a method and apparatus for laminating glass articles using short wave radiation such as microwave and/or infrared to rapidly apply heat in a vacuum to thermally treat adhesive film. The '284 patent requires a preheating chamber and preheating step prior to heating with electromagnetic radiation. U.S. Patent Publication No. 2010/0101646 A1 Cadwallader et al. teaches a process for manufacturing solar cell modules using infrared heating. U.S. Patent Publication No. 2007/0034317 A1 Sklyarevich et al. a method and apparatus for laminating glass sheets using infrared radiation.

However, none of these prior art systems provide for a glass lamination system where the glass laminate is heated via infrared heaters, where the infrared heaters are arranged to allow for heating zones and can be controlled so that the glass is first heated in the center and then outwards towards it edges by controlling the infrared heaters. None of these prior art systems provide a system having an infrared heater module with controlled heating zones, so that air and moisture are removed from the glass laminate material via heat and vacuum pressure zones.

None of these prior art references solve the problem of using infrared heating for large pieces of glass and glass laminate.

Thus, it is desirable to provide a glass lamination system that uses infrared heaters, where the infrared heaters are arranged to allow for heating zones and can be controlled so that glass laminate is first heated in the center and then outwards towards it edges by controlling the infrared heaters.

It is further desirable to provide a glass lamination system using infrared heating for heating large pieces of glass.

### SUMMARY OF THE INVENTION

Accordingly, it is an object of the present invention to provide a glass lamination system that uses infrared heating.

It is another object of the present invention to provide an infrared heating system where the infrared heaters are arranged to allow for heating zones and can be controlled so that glass laminate is first heated in the center and then outwards towards it edges by controlling the infrared heaters. Having the glass be heated in zones first in the center and then outwards towards it edges allows for air and moisture to the forced radially from the center of the glass laminate to the outer edges of the glass laminate, thus, eliminating air or moisture bubbles in the glass laminate material. This is advantageous as it provides for a glass laminate material that is more uniform and has fewer defects.

It is a further object of the present invention to provide a glass lamination system using infrared heating for heating large pieces of glass. Large pieces of glass are typically difficult to heat and using zoned heating on large pieces of glass is an effective way to laminate large pieces of glass without producing defects in the glass caused by air or moisture.

It is a further object of the present invention to heat multiple pieces of glass at the same time and to heat multiple pieces of glass using infrared heating.

These and other objects of the invention are achieved by providing a system for laminating glass, the system comprising: a first heating module, the first heating module including at least one infrared heating unit, the at least one infrared heating unit arranged to provide at least two heating zones for heating a laminated material, the at least two heating zones heating different sections of the laminated material, wherein the first heating module includes drawing a vacuum around the laminated material during operation of the first heating module; a second heating module, the second heating module having at least one heating unit, the least one heating unit of the second heating module heating the laminated material at atmospheric pressure and via convection; and a cooling module, the cooling module cooling the laminated material via convection.

In certain embodiments, the at least two heating zones of the first heating module includes a center heating zone and an outer heating zone adjacent and surrounding the center heating zone. In certain embodiments, the first heating module heats the laminated material first in the center heating zone and then the outer heating zone.

In certain embodiments, more than two heating zones are provided which can be arranged concentrically in rows across the width of the first heating module or across the length of the first heating module.

In certain embodiments, the infrared heaters in the different heating zones operate at different temperatures.

In certain embodiments, the infrared heating units in the first heating module are arranged concentrically in rows across the width of the first heating module or across the length of the first heating module.

In certain embodiments, more than two heating zones are provided which can be arranged concentrically in rectangular rings in the first heating module.

In certain embodiments, the infrared heating units in the first heating module are arranged concentrically in rectangular rings across the first heating module.

In certain embodiments, the first heating module has four heating zones, whereby at least one infrared heating unit is arranged in each heating zone. In certain embodiments, each heating zone includes infrared heating units that are arranged in concentric rectangular rings in the different heating zones.

In certain embodiments, the first heating module includes at least two infrared heating units, wherein at least one infrared heating unit is located below the laminated material and wherein at least one infrared heating unit is located above the laminated material. More specifically, in certain embodiments the at least one infrared heating unit may be located within the top frame of the first heating module. In certain embodiments, at least one infrared heating unit is located below the conveyor belt in the first module.

In certain embodiments, one of the at least two infrared heating units may be substituted with a convection unit.

In certain embodiments, the at least one infrared heating unit include a thermocouple. In certain embodiments, the thermocouple is located between a bladder and the laminated material. In certain embodiments, the bladder is made from silicone or other flexible materials. In certain embodiments, the thermocouple is located inside the at least one infrared heating unit. In certain embodiments, the thermocouple is physically in contact with the laminated material.

In certain embodiments, the laminated material cannot oscillate in the first heating module.

In certain embodiments, the infrared heating units in the first heating module are arranged, so that each infrared heating unit extends across the width of the first heating module or across the length of the first heating module. In certain embodiments, the infrared heating units are arranged in series, so that more than one infrared heating unit extends across the width of the first heating module or across the length of the first heating module.

In certain embodiments, the first heating module includes a top frame, a conveyor belt, and a bladder, wherein the bladder is located within the top frame and wherein when the top frame is lowered, a seal is formed between the conveyor belt and the bladder.

In certain embodiments, the bladder has more than one point of connection to the vacuum system in the first module. In certain embodiments, an airtight seal is formed between the bladder and the conveyor belt.

In certain embodiments, once the seal is formed between the conveyor belt and the bladder, the vacuum is drawn around the laminated material during at least part of the operation of the first heating module.

In certain embodiments, the vacuum around the laminated material is varied during operation of the first heating module. In certain embodiments, the vacuum is released once an edge seal is created in the laminated material.

In certain embodiments, drawing a vacuum around the laminated material in the first heating module includes occurs during all or part of the operation of the first heating module. The heating in the first heating module occurs under vacuum.

In certain embodiments, the infrared heating units heat the laminated material through the conveyor belt and the bladder, and do not directly act upon the laminated material. In certain embodiments, the conveyor belt in the first heating module is a solid belt.

In certain embodiments, the infrared heating units are operated by raising the temperature of the infrared heating units to a first temperature and then to a second temperature during heating of the glass laminated material.

In certain embodiments, the first heating module may heat more than one piece of laminated material at the same time. In certain embodiments, preferably two or three pieces of material are heated at the same time in the first heating module. In certain embodiments, the laminated material may be rectangular, trapezoidal or circular.

In certain embodiments, an optical pyrometer is located at the exit point of the first module so that the temperature of the laminated material is measured as the laminated material indexes from the first heating module to the second heating module.

In certain embodiments, the system includes at least one press roll located between each of the modules, where each press roll includes a top roll and a bottom roll. Specifically, at least one press roll can be located between the first module and the second module and/or between the second module and the third module. In certain embodiments, at least one press roll can be located in both locations. In certain embodiments, the at least one press roll helps seal the edges of the laminated material.

In certain embodiments, the infrared heaters promote the removal of water and moisture from the laminate material.

In certain embodiments, the second heating module includes more than one heating unit. In certain embodiments, the second heating module includes at least one heating unit above the conveyor belt in the second heating module and at least one heating unit below the conveyor belt in the second heating module. In certain embodiments, the conveyor belt may be replaced by rollers. In certain embodiments, the conveyor belt may be automatic or manually controlled. In certain embodiments, the conveyor belt in the second heating module may be an open belt and may allow for convection heating through the belt. In certain embodiments, the conveyor belt in the second heating module is flexible. The conveyor belt is preferably flexible, otherwise it cannot make turns around conveyor rolls that power the belt.

In certain embodiments, the second heating module includes doors to close the second heating module. In certain embodiments, the doors keep the heat from exiting the second heating module. In certain embodiments, the laminated material oscillates back and forth in the second heating module. In certain embodiments, the oscillation of the laminated material in the second heating module allows for even heating of the laminated material.

In certain embodiments, the cooling module includes nozzles that provided ambient temperature air to cool the laminated material. In certain embodiments, the cooling module includes air knives and perforated steel to guide the air to the glass.

In certain embodiments, the laminated material oscillates back and forth in the cooling module. In certain embodiments, the cooling module allows for even cooling of the laminated material.

In certain embodiments, the laminated material is composed of at least two sheets of material and at least one interlayer between at least two sheets of material. In certain embodiments, the interlayer bonds the at least two sheets of material together after being processed by the system.

In certain embodiments, the system includes a loading module and an unloading module for the laminated material. In certain embodiments, the loading and unloading modules contain rollers. In certain embodiments, the rollers are automatic. In certain embodiments, the rollers work on a forward/reverse variable control. In certain embodiments, the rollers are driven by a motor.

In certain embodiments, the first heating module, second heating module and cooling module include a conveyor belt system. In certain embodiments, the conveyor belt system of the first heating module, second heating module and cooling module is automatically powered or driven by a motor.

In certain embodiments, the laminate material indexes from and into the first heating module, second heating module and cooling module.

Other objects of the invention are achieved by providing a method for manufacturing a glass laminated product, the method comprising the steps of: providing a laminated material and an interlayer material; heating the laminated material and the interlayer material via infrared heating and under a vacuum in a first heating step, the first heating step including heating the laminated material and the interlayer material in at least two heating zones, the at least two heating zones heating different sections of the laminated material and the interlayer material; heating the laminated material and the interlayer material via convection heating and at atmospheric pressure in a second heating step, the second heating step including at least one heating unit; and cooling the laminated material and the interlayer material via convection.

In certain embodiments, in the first heating step, the at least two heating zones include a center heating zone and an outer heating zone adjacent and surrounding the center heating zone, wherein the center heating zone is heated before the outer heating zone is heated. In certain embodiments, the infrared heaters in the different heating zones operate at different temperatures. In certain embodiments, the infrared heaters are heated first in the center zones, to promote the removal of water and moisture from the laminate material.

In certain embodiments, the first heating step involves forming an edge seal in the interlayer material, to bond the interlayer material to the laminated material.

In certain embodiments, the first heating step involves lowering a top frame having a bladder onto a conveyor belt and creating a seal between the conveyor belt and the bladder to create the vacuum. In certain embodiments, the infrared heating involves heating the laminated material through the conveyor belt and the bladder.

In certain embodiments, the first heating step takes as short as 10 minutes and as long as required for the laminate. The first heating step may take up to 90 minutes to complete, but it may take a longer amount of time. The length of time to complete the first heating step depends on the thickness of the laminated material.

In certain embodiments, the second heating step takes between 10 to 90 minutes to complete, but may take a longer amount of time depending upon the thickness of the laminated material. In certain embodiments, the second heating step involves recirculating hot air from the at least one heating unit.

In certain embodiments, the second heating step involves curing the interlayer material.

In certain embodiments, the cooling step takes between 10 to 90 minutes to complete, but may take a longer amount of time depending upon the thickness of the laminated material. In certain embodiments, the cooling step includes nozzles that provided ambient temperature air to cool the laminated material.

In certain embodiments, the glass laminated product exits the cooling module at 30 degrees Fahrenheit above ambient. In certain embodiments, the glass laminated product may exit the cooling module at a temperature higher or lower than 30 degrees Fahrenheit above ambient.

Other objects of the invention are achieved by providing a method for manufacturing a laminated product, the method comprising the steps of: providing a laminated material, the laminated material being composed of at least two sheets of material and at least one interlayer between at least two sheets of material; heating the laminated material via infrared heating and under a vacuum in a first heating step, the first heating step including heating the laminated material and the interlayer material in at least two heating zones, the at least two heating zones including a center heating zone and an outer heating zone adjacent and surrounding the center heating zone, wherein the center heating zone is heated prior to the outer heating zone being heated, wherein heating of the laminated material is done until an edge seal in the at least one interlayer material is created, wherein once the edge seal is created, the vacuum is released; heating the laminated material and the interlayer material via convection heating and at atmospheric pressure in a second heating step, the second heating step including curing the at least one interlayer material; and cooling the laminated material and the interlayer material via convection by impinging ambient temperature air on the laminated material.

Other objects of the invention are achieved by providing a system for laminating glass, the system comprising: a first heating module, the first heating module including at least one infrared heating unit, the at least one infrared heating unit arranged to provide at least two concentric heating zones for heating a laminated material, the at least two concentric heating zones heating different sections of the laminated material, wherein the first heating module includes drawing a vacuum around the laminated material during operation of the first heating module, and wherein operation of the first heating module promotes the removal of air and moisture from the laminating glass; a second heating module, the second heating module having at least one heating unit, the least one heating unit of the second heating module heating the laminated material at atmospheric pressure and via convection; and a cooling module, the cooling module cooling the laminated material via convection.

In certain embodiments, the at least two concentric heating zones include a center heating zone, a middle heating zones and an outer heating zone.

In certain embodiments, the center heating zone is heated first and before the middle heating zone and the outer heating zone is heated.

In certain embodiments, the middle heating zones is heated second and the outer heating zone is heated last during operation of the first heating module.

In certain embodiments, the center, middle and outer heating zones are heated at the same temperature.

In certain embodiments, the center heating zone is heated at a temperature higher than the middle and the outer heating zones.

In certain embodiments, the center, middle and outer heating zones are sequentially powered on and the power is kept on during operation of the first heating module.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a top view of a glass lamination system of an embodiment of the invention;

FIG. 2 is side view of the glass lamination system of FIG. 1;

FIG. 3 is a perspective view of the glass laminate used in FIG. 1;

FIG. 4 is a side view of the infrared heating module of the glass lamination system of FIG. 1 having the glass laminate inserted into it;

FIG. 5A is a side view of the infrared heating module of the glass lamination system of FIG. 1 in an open or off position;

FIG. 5B is a side view of the infrared heating module of the glass lamination system of FIG. 1 in a closed or on position;

FIG. 5C is a top view of the top frame of an array of infrared heating modules of an embodiment of the invention;

FIG. 5D is a schematic view of the top frame of the infrared heating module in an embodiment of the invention;

FIG. 6 is a side view of the convection heating module of the glass lamination system of FIG. 1; and

FIG. 7 is a side view of the cooling module of the glass lamination system of FIG. 1.

### DETAILED DESCRIPTION OF THE INVENTION

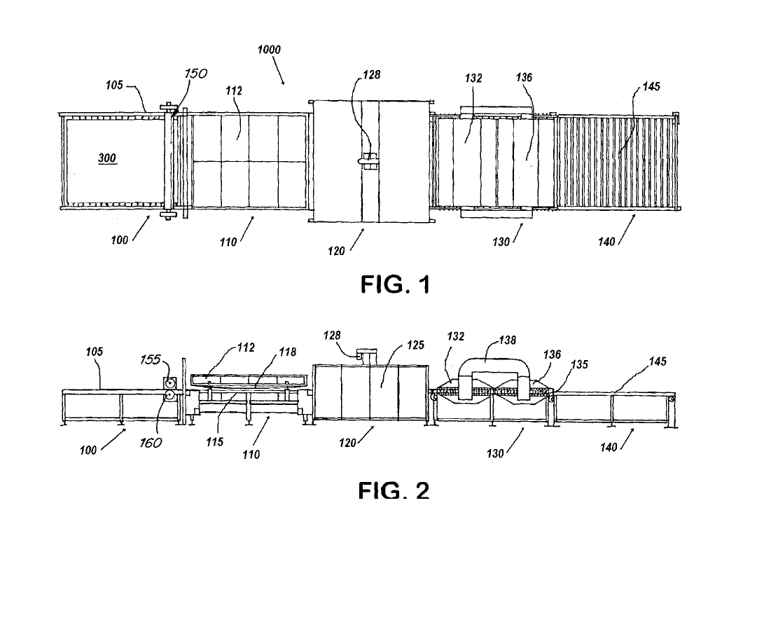

FIGS. 1 and 2 illustrate a top and side view of a glass lamination system of an embodiment of the invention. FIGS. 1 and 2 show system 1000 having various modules arranged in an assembly for laminating glass.

FIG. 1 shows module 100, which is where the glass laminate 300 enters the assembly or system 1000. Module 100 has rollers 105, the rollers 105 allowing for the glass laminate 300 to be rolled along the module 100. In certain embodiments, the rollers 105 may be automated or may a conveyor belt instead of rollers 105. Module 100 is an entrance module, where the glass laminate 300 enters the assembly or system 1000.

In certain embodiments, when a conveyor belt is used, the conveyor belt material is very thin, about 0.010″ thick, so that infrared heating elements may be used. In preferred embodiments, the thickness of the conveyor belt is less than 0.2″ thick. The thinness of the belt allows infrared heat from the infrared heaters to pass through the belt quickly. In preferred embodiments, the conveyor belt is made from a material that has good thermal conductivity.

In various embodiments, the rollers may be on 8″ centers with donuts and may work in both a forward and reverse direction for variable control of movement of glass laminate 300. The module 100 is used for loading of glass and glass laminate 300 into the system 1000. Glass laminate is shown as element 300 in FIG. 1.

Module 110 is an infrared and vacuum heating system. The top part (top frame) 112 of the infrared heating system in module 110 may have various infrared heaters. A bladder 118 is arranged connected to top part 112 of module 110, the bladder allowing for a seal to form, so that a vacuum is established in module 110 when the module 110 is operational. Module 110 has a conveyor assembly 115, which carries forward the glass laminate 300.

Module 120 is a convection heating system. Module 120 is shown having conveyor assembly 125, which carries forward the glass laminate 300. Module 120 is also shown having a vent 128. The vent 128 allows for heat to be released from module 120.

Module 130 is a cooling module. Module 130 is shown having a conveyor assembly 135. Module 130 is a convection cooling system having various jets and air knives used to cool glass laminate 300. This module has sections 132 and 136, which hold and attach various jets and piping 138, which provides air to the jets. In certain embodiments, the piping may provide for water used to cool circulated air, so that the circulated air can be used to cool glass laminate 300.

Module 140 has rollers 145 allowing for glass laminate 300 to be rolled along the module 140. In certain embodiments, the rollers may be automated or may be replaced by a conveyor belt. Module 140 is an end module, where the glass laminate 300 exits the system. In certain embodiments, the glass lamination system 1000 includes at least one press roll 150 as shown in FIG. 1. Press roll 150 may include a top roll 155 and bottom roll 160 as shown in FIGS. 2 and 4. In certain embodiments, at least one additional press roll may located between module 110 and module 120. In certain embodiments, at least one additional press roll may located between module 120 and module 130 and/or between module 130 and module 140.

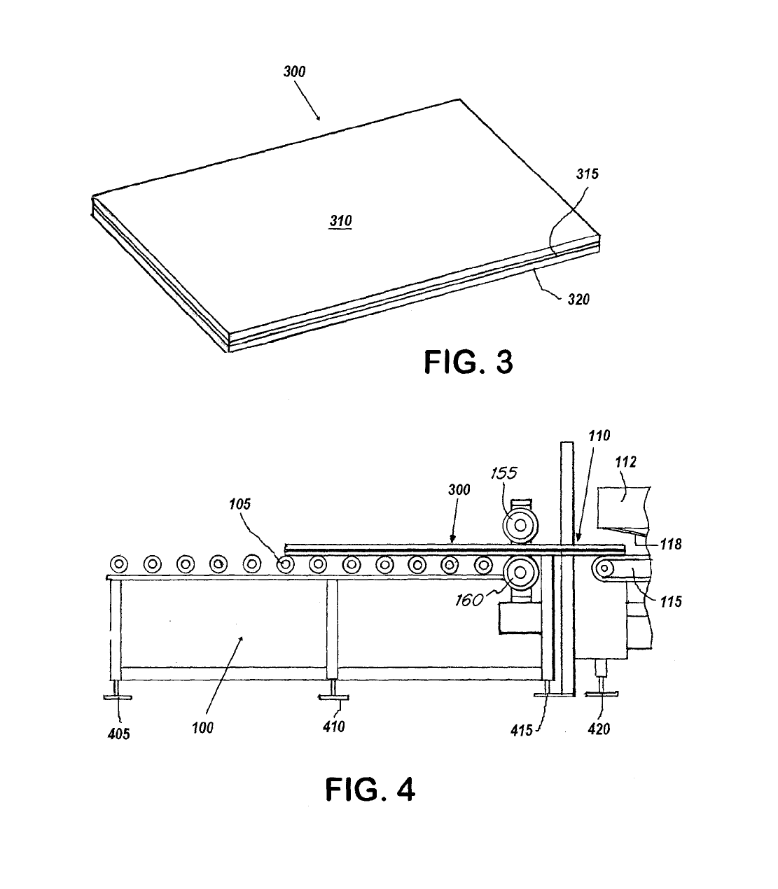

FIG. 3 shows glass laminate 300 of an embodiment of the invention. Glass laminate 300 is made of interlayer material 315 sandwiched between two sheets of material 310 and 320. The interlayer material may be is textured, may be flexible or rigid, and may have ridges formed on the material.

The interlayer material and two sheets of material are described in U.S. patent application Ser. No. 13/085,224 entitled “Method For Vacuum Laminating Glass Without The Use Of Preconditioned Interlayer Material Or An Autoclave.” This application was filed on filed Apr. 12, 2011 and was published as U.S. Patent Publication No. 2011/0247754. The contents of U.S. patent application Ser. No. 13/085,224 are incorporated into this patent application in its entirety.

FIG. 4 shows glass laminate 300 being moved along module 100 and into module 110. Module 100 has rollers 105 and has a frame as well as legs 405, 410 and 415. Certain embodiments of module 100 may have a greater or fewer number of legs than shown.

FIG. 4 also shows module 110 having a top portion 112, and bladder 118 as well as conveyor assembly 115. Module 110 is contains an infrared and vacuum heating system. FIG. 4 shows the glass laminate material being indexed from module 100 to module 110.

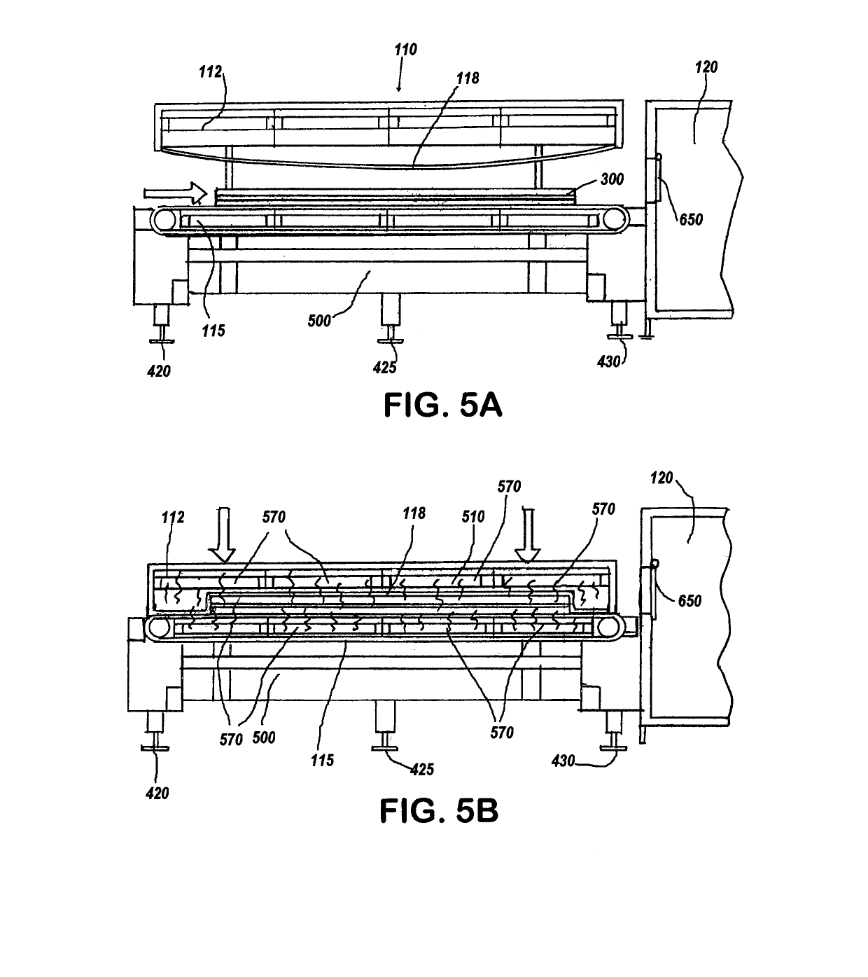

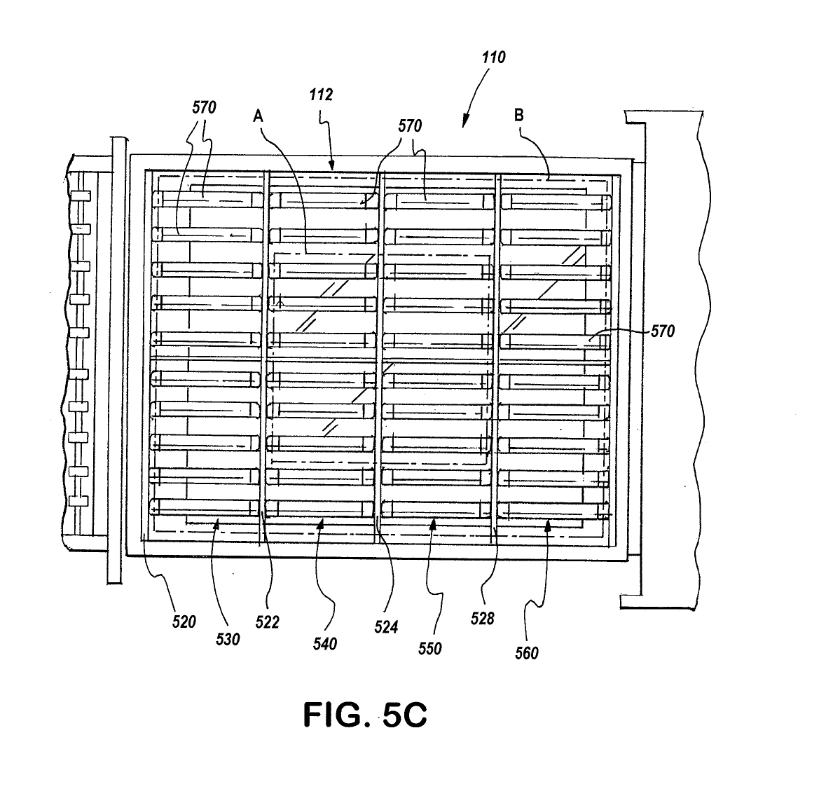

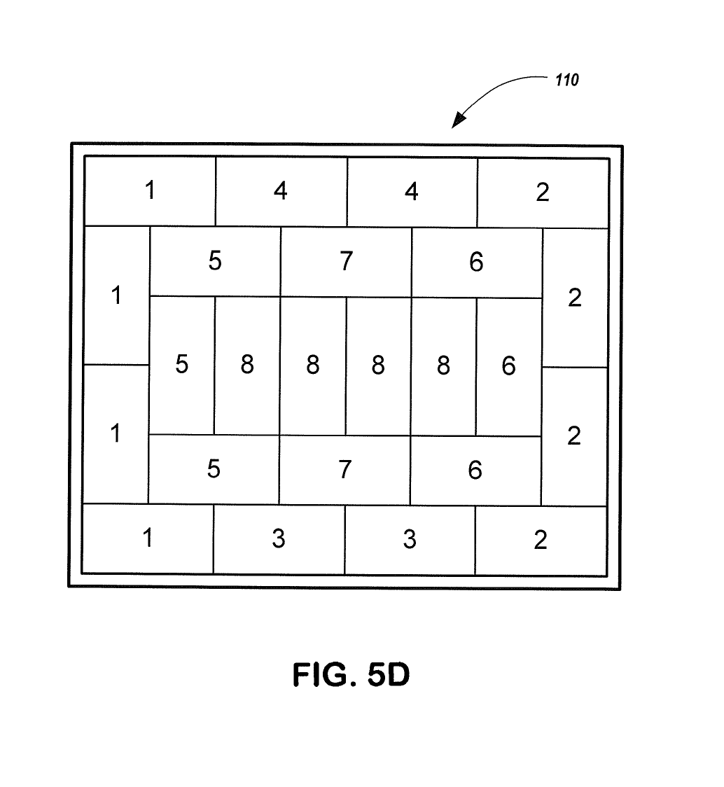

FIG. 5A shows infrared heating module 110 having a top frame 112 and bladder 118, as well as conveyor 115 and frame 500. FIG. 5A also shows legs 420, 425 and 430 supporting the frame 500.

FIG. 5A shows the bladder and top assembly in the open or off position, whereby this module is not in an operational mode to heat the glass laminate 300. Module 110 also has conveyor system 115 that is able to move the glass lamiante forward in an indexing manner through the module 110.

FIG. 5B shows infrared heating module 110 in closed or “on” mode, where the infrared heating modules are being used. Here, top frame 112 is shown in its closed position, where the bladder forms a seal around the glass laminate and infrared heating can occur.

FIG. 5B shows infrared heating units 570 are arranged in the frame 500 (bottom frame) and in the top frame 112 of heating module 110. In FIG. 5B, the infrared heating units 570 are arranged within the conveyor belt system. The infrared heating units 570 radiate heat through the conveyor belt 115.

In certain embodiments, the infrared heating units 570 may be arranged within or below the conveyor system.

In various embodiments, the infrared heating module 110 uses a silicone conveyor belt and heats the glass laminate for approximately 20 to 40 minutes. However, the infrared heating module 110 may heat the glass laminate for more than 40 minutes in certain embodiments. In certain embodiments, the infrared heating units 570 heat the glass laminate material 300 through the conveyor belt and 115 and the bladder 118.

The infrared heating module 110 may perform a stepwise method to heat the glass in certain embodiments. The stepwise method involves (1) the glass being indexed into place under the top frame 112; (2) top frame 112 being lowered and a seal being formed between conveyor belt 115 and a bladder; (3) vacuum being drawn around glass in a prescribed manner; (4) quartz tubular infrared heaters arranged in the top frame and bottom below the convey belt 115 heating the glass through the bladder to form an edge seal on interlayer material; (5) once an edge seal is created, the vacuum is released; (6) pneumatic cylinders lift top frame off glass; and (7) hot glass indexes into convection heating module. In certain embodiments, the bladder is is flexible and is about 0.125″ thick. In certain embodiments, the bladder is made from silicone and is flexible.

Other methods may also be used whereby various heating zones are employed and various infrared heating units are controlled in various heating zones. Other methods involve heating the glass in the center portion and then outwards in other zones.

FIG. 5C shows an embodiment of the invention where various infrared heaters are shown in top frame 112. Here, infrared heating units 570 are shown arranged in series extending across the length of the heating module 110. There are rows of infrared heating units 530, 540, 550, and 560. Brackets 520, 522, 524 and 528 may be used to hold the infrared heating units 530, 540, 550, and 560. In certain embodiments, infrared heating units may be quartz tubular infrared heaters. Other infrared heating units are also possible and may be used in module 110.

Heating zones 530, 540, 550 and 560 are shown in FIG. 5C. In certain embodiments, the infrared heating units in heating zones 540 and 550 may be turned on or controlled prior to the infrared heating units in heating zone 530 and 560. This allows the center of the glass laminate to be heated prior to the edges of the glass lamiante 300.

In other embodiments, the heating zones include zone A and zone B. Zone A may include on the infrared heating units in the center of the heating module 110, where all infrared heating unit outside the center are part of heating zone B. This allows the center of the glass laminate to be heated prior to the edges of the glass lamiante 300.

In other embodiments, the infrared heating units 570 may extend across the width of the heating module 110 (not shown). In other embodiments, infrared heating units 570 may extend from one end of the heating module 110 to the other end of the heating module.

In certain embodiments, a circuit control can be used to control the infrared heating units 570 of module 110, so that a user can control which heating units are operational. In certain embodiments, the circuit control is used to power the infrared heating units 570.

In certain embodiments, the infrared heating module 110 includes at least one sensor to detect if the glass laminate forms an edge seal, which then causes the infrared heating units 570 to turn off and the vacuum to be released.

In certain embodiments, the infrared heating module 110 includes at least one process control thermocouple. The at least one process control thermocouple may be introduced through the bladder and may monitor the temperature of the glass laminate material 300. In certain embodiments, the thermocouple is located between the bladder and glass. In certain embodiments, the thermocouple is located inside the infrared heating units.

In certain embodiments, in infrared heating module 110, air and moisture is removed during infrared heating. The removal of air and moisture seals the edges of the glass laminate material 300, so the glass laminate material can index to the convection station 120. Since the edges of the glass laminate material 300 are heated faster than the interior, the interlayer material melts more quickly on the edges of the material forming the seal.

To determine the time that the glass laminate material is heated in the infrared heating module, a method or process may be used whereby a glass laminate material is placed in the infrared heating module 110 and a thermocouple is used to determine the temperature at which the edges of the glass laminate material begin to seal. After approximately two iterations, a temperature versus time graph can be calculated that allows for an approximate determination of the temperature and time that the glass laminate material begins to form a seal based upon its thickness and the materials used. In certain embodiments, the thermocouple may be located between the glass and interlayer material during testing, so that an accurate temperature of the glass and interlayer material is taken.

A user can use this graph calculated by the iterative process to approximate the amount of time that the glass laminate material is in the infrared heating module. The user will then know approximately how long each piece of glass laminate should be indexed through the infrared heating module 110.

In certain embodiments, the infrared heating module 110 is connected to a computer or to an input device so that a user may control the infrared heating units 570.

In certain embodiments, a user can control the infrared heating units 580, 582, 584, 586 and 588 and the infrared heating module 110 is connected to a computer or to an input device.

FIG. 5D shows another embodiment of the invention where infrared heating units are arranged in module 110. In this embodiment, infrared heaters are arranged in zones 1, 2, 3, 4, 5, 6, 7, and 8 as shown in FIG. 5D. A user may control the heating to the infrared heating units located in the various zones.

In certain embodiments, the innermost zones (8) are first heated, followed by heating the middle zones 5-6 and then the outer zones 1-4. In other embodiments, a user can control the zones that are heated first.

In certain embodiments, the infrared heaters may either have medium wavelength or short wavelength output. The heaters may have a low mass so that they can change in energy output quickly.

The advantages of each type of heater is short wavelength tends to penetrate into a glass laminate material 300 more than a medium wavelength heater. The medium wavelength heaters tend to have their energy absorbed more on the surface of the material and then rely on conduction to bring the energy through the material to reach the glass laminate material 300 inside the container. Short wavelength heaters are of a much higher intensity than the medium wavelength heaters. Both short wavelength and medium wavelength heaters heat the glass laminate through the bladder or belt.

In certain embodiments, the infrared heaters may be fast response infrared heaters. Such infrared heaters are continuously bonded to a high temperature insulating refractory board, which stabilizes the infrared heaters and establishes uniform heating across the infrared heaters.

In certain embodiments, a thermocouple is located behind an infrared heater to accurately measure the emitter temperature of the infrared heater. In certain embodiments, the infrared heater includes PLC or analog control with closed loop feedback, so that product temperature may be maintained within +/−2° F. across the infrared heater. In certain embodiments, the thermocouples are replaceable.

In certain embodiments, at least one optical pyrometer measures the temperature on the back (outside) of the bladder. In certain embodiments, the at least one optical pyrometer is located behind the infrared heater to measure the temperature of the glass laminate 300. The infrared heater may have a through hole to receive the at least one optical pyrometer. In certain embodiments, the optical pyrometer is located between the first and second heating module to measure the temperature of the laminate 300 as it indexes from the first heating module to the second heating module.

In certain embodiments, tubular quartz infrared heaters may be used. When using tubular quartz infrared heaters, the heating zones may require that the infrared heaters run in the long direction and on 2-3″ center blocks. In other embodiments, a block may be fabricated with the heating elements running also in the long direction and also on 2-3″ centers. The quartz infrared heaters may include a thermocouple installed in a quartz thermowell and may include a helical resistor coil, permanent internal reflector, and coil retention groove. A heavy wall quartz tube may surround these internal components. In certain embodiments, the internal reflector is a gold reflector that does not oxide like other metallic reflectors.

In certain embodiments, at least one infrared heater has an internal reflector which has a groove to position the coil in the heater. In certain embodiments, the average watt density of the infrared heaters will be between 10 and 20 watts per square inch.

In certain embodiments, the infrared heaters include air holes for extremely rapid cool down for cycling process air. In certain embodiments, the infrared heaters include premounted fans and integrated exhausts. In certain embodiments, the infrared heaters are complete systems with controls for controlling the output of the infrared heaters.

In certain embodiments, the infrared heaters work for large pieces of glass laminate material as the multiple zones allow for a controlled method of heating the large piece of glass laminate material.

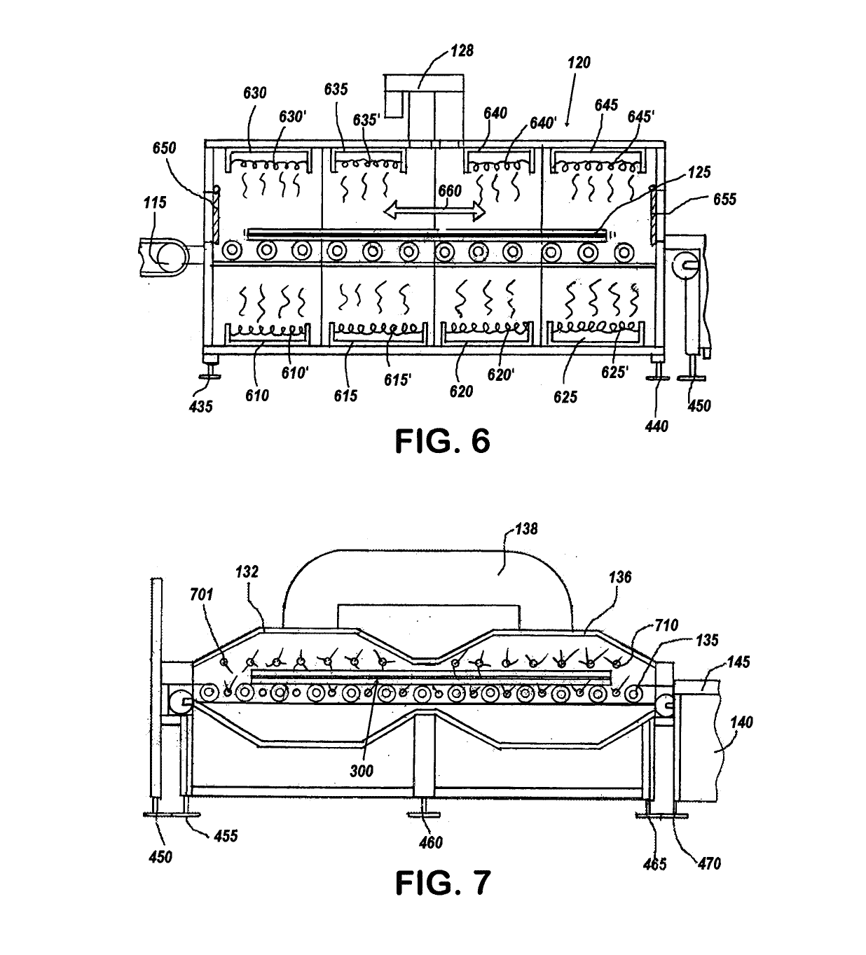

FIG. 6 shows convection heating module 120. Convection heating module 120 has a conveyor 125 and convection heaters 610, 615, 620, 625, 630, 635, 640 and 645. These convection heaters have coils 610′, 615′, 620′, 625′, 630′, 635′, 640′ and 645′ respectively.

Conveyor 125 allows for glass laminate 300 to move from side to side as shown by arrow 660 within convection heating module 120. Convection heating module 120 is shown with a frame and legs 435 and 440. Also shown are doors 650 and 655 which close when module 120 heats the glass laminate 300.

In certain embodiments, the conveyor 125 may be replaced by rollers. The rollers may be on 8″ centers and may have a KEVLAR® wrap or a stainless steel wrap to keep them from melting when the heat is applied. The convection heating module 120 may heat the glass laminate 300 for approximately 20 to 40 minutes, but may take a longer amount of time depending upon the thickness of the laminated material.

In the convection heating module 120, hot air may be recirculated rather than exhausted to save time and energy. Module 120 may perform a stepwise method. The stepwise method involves (1) glass being indexed into convection module 120 (convection oven); (2) oven doors close and glass is heated from the top and bottom; (3) glass oscillates back and forth for even heating; and (4) once interlayer cures the glass lamiante, the oven doors open and the glass indexes to the next section.

In certain embodiments, a greater or fewer number of convection heaters and convection coils may be used in the convection heating module 120. In certain embodiments, the convection heaters and convection coils may be located either above or below the conveyor belt or both below and above the conveyor belt and glass laminate 300.

FIG. 7 shows cooling module 130. Cooling module 130 is a convection cooling module of the system 1000. Module 130 has sections 132 and 136 and conveyor 135. The glass is supported by the conveyor 135.

Module 130 has a frame and is supported by legs 455, 460 and 465. Air knives (jets) 701 and 710 are shown providing air to cool the glass laminate 300.

In certain embodiments, the conveyor 135 is replaced by rollers on typically 8″ centers with KEVLAR® or stainless steel wrap. In certain embodiments, ambient temperature air impinges on the glass through nozzles in the top and the bottom of module 130. In certain embodiments, the glass is cooled for approximately 20 to 40 minutes.

Module 130 may perform a stepwise method. The method involves (1) glass being indexed into the cooling module; (2) glass oscillating back and forth for even cooling; and (3) glass exiting the conveyor at approximately 30 degrees Fahrenheit above ambient temperature of air. Leaving the glass laminate material 300 in the infrared heating station longer than necessary increases overall cycle time for the process.

In certain embodiments, air is used to cool the glass laminate. In other embodiments, water or other gases may be used instead of air.

While the invention has been specifically described in connection with certain specific embodiments thereof, it is to be understood that this is by way of illustration and not of limitation and that various changes and modifications in form and details can be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention

What is claimed is:

1. A system for laminating glass, the system comprising:
a first heating module, the first heating module including
at least one infrared heating unit, the at least one infrared heating unit arranged to provide at least two heating zones for heating a laminated material, the at least two heating zones heating different sections of the laminated material,
wherein the first heating module includes drawing a vacuum around the laminated material during operation of the first heating module;
a second heating module, the second heating module having at least one heating unit, the least one heating unit of the second heating module heating the laminated material at atmospheric pressure and via convection; and
a cooling module, the cooling module cooling the laminated material via convection.

2. The system of claim 1, wherein the at least two heating zones include a center heating zone and an outer heating zone adjacent and surrounding the center heating zone.

3. The system of claim 2, wherein the first heating module heats the laminated material first in the center heating zone and then the outer heating zone.

4. The system of claim 1, wherein more than two heating zones are provided which can be arranged concentrically in rows across the width of the first heating module or across the length of the first heating module.

5. The system of claim 1, wherein the first heating module includes at least two infrared heating units, wherein at least one infrared heating unit is located below the laminated material and wherein at least one infrared heating unit is located above the laminated material.

6. The system of claim 5, wherein one of the at least two infrared heating units is substituted with a convection unit.

7. The system of claim 1, wherein the first heating module includes a top frame, a conveyor belt, and a bladder, wherein the bladder is located within the top frame and wherein when the top frame is lowered, a seal is formed between the conveyor belt and the bladder.

8. The system of claim 7, wherein at least one of the infrared heating units heats the laminated material through the conveyor belt and wherein at least one of the infrared heating units heats the laminated material through the bladder.

9. The system of claim 7, wherein the bladder has more than one point of connection to the vacuum system.

10. The system of claim 7, wherein once the seal is formed between the conveyor belt and the bladder, the vacuum is drawn around the laminated material during at least part of the operation of the first heating module.

11. The system in claim 10 wherein the vacuum around the laminated material is varied during operation of the first heating module.

12. The system of claim 10, wherein the vacuum is released once an edge seal is created in the laminated material.

13. The system of claim 1, wherein the system includes at least one press roll having a top roll and a bottom roll.

14. The system of claim 13, wherein the at least one press roll is located between the first heating module and the second heating module or between the second heating module or the third heating module or both.

15. The system of claim 13, wherein the at least one press roll helps seal the edges of the laminated material.

16. The system of claim 1, wherein drawing a vacuum around the laminated material in the first heating module includes occurs during all or part of the operation of the first heating module.

17. The system of claim 1, wherein the laminated material oscillates back and forth in the second heating module.

18. The system of claim 1, wherein the laminated material oscillates back and forth in the cooling module.

19. The system of claim 1, wherein the laminated material is composed of at least two sheets of material and at least one interlayer between at least two sheets of material.

20. The system of claim 19, wherein the interlayer bonds the at least two sheets of material together after being processed by the system.

21. The system of claim 1, wherein operation of the first heating module promotes the removal of air and moisture from the laminated material.

22. A method for manufacturing a glass laminated product, the method comprising the steps of:
providing a laminated material and an interlayer material;
heating the laminated material and the interlayer material via infrared heating and under a vacuum in a first heating step, the first heating step including heating the laminated material and the interlayer material in at least two heating zones, the at least two heating zones heating different sections of the laminated material and the interlayer material;
heating the laminated material and the interlayer material via convection heating and at atmospheric pressure in a second heating step, the second heating step including at least one heating unit; and
cooling the laminated material and the interlayer material via convection.

23. The method of claim 22, wherein, in the first heating step, the at least two heating zones include a center heating zone and an outer heating zone adjacent and surrounding the center heating zone, wherein the center heating zone is heated before the outer heating zone is heated.

24. The method of claim 22, wherein the first heating step involves forming an edge seal in the interlayer material, to bond the interlayer material to the laminated material and to remove air and moisture from the laminated material.

25. The method of claim 24, wherein, in the first heating step, the vacuum is released once the edge seal in the interlayer material is created.

26. The method of claim 22, wherein the first heating step involves lowering a top frame having a bladder onto a conveyor belt and creating a seal between the conveyor belt and the bladder to create the vacuum.

27. The method of claim 22, wherein the first heating step takes between 10 to 90 minutes to complete.

28. The method of claim 22, wherein the second heating step takes between 10 to 90 minutes to complete.

29. The method of claim 22, wherein the second heating step involves recirculating hot air from the at least one heating unit.

30. The method of claim 22, wherein the second heating step involves curing the interlayer material.

31. The method of claim 22, wherein the cooling step takes between 10 to 90 minutes to complete.

32. A method for manufacturing a laminated product, the method comprising the steps of:
providing a laminated material, the laminated material being composed of at least two sheets of material and at least one interlayer between at least two sheets of material;
heating the laminated material via infrared heating and under a vacuum in a first heating step, the first heating step including heating the laminated material and the interlayer material in at least two heating zones, the at least two heating zones including a center heating zone and an outer heating zone adjacent and surrounding the center heating zone, wherein the center heating zone is heated prior to the outer heating zone being heated, wherein heating of the laminated material is done until an edge seal in the at least one interlayer material is created, wherein once the edge seal is created, the vacuum is released;
heating the laminated material and the interlayer material via convection heating and at atmospheric pressure in a second heating step, the second heating step including curing the at least one interlayer material; and
cooling the laminated material and the interlayer material via convection by impinging ambient temperature air on the laminated material.

33. A system for laminating glass, the system comprising:
a first heating module, the first heating module including
at least one infrared heating unit, the at least one infrared heating unit arranged to provide at least two concentric heating zones for heating a laminated material, the at least two concentric heating zones heating different sections of the laminated material,
wherein the first heating module includes drawing a vacuum around the laminated material during operation of the first heating module, and
wherein operation of the first heating module promotes the removal of air and moisture from the laminated material;
a second heating module, the second heating module having at least one heating unit, the least one heating unit of the second heating module heating the laminated material at atmospheric pressure and via convection; and
a cooling module, the cooling module cooling the laminated material via convection.

34. The system of claim 33, wherein the at least two concentric heating zones include a center heating zone, a middle heating zone and an outer heating zone.

35. The system of claim 34, wherein the center heating zone is heated first and before the middle heating zone and the outer heating zone is heated.

36. The system of claim 35, wherein the middle heating zones is heated second and the outer heating zone is heated last during operation of the first heating module.

37. The system of claim 34, wherein the center heating zone, the middle heating zone and the outer heating zones are heated at the same temperature.

38. The system of claim 34, wherein the center heating zone is heated at a temperature higher than the middle and the outer heating zones.

39. The system of claim 34, wherein the center, middle and outer heating zones are sequentially powered on and the power is kept on during operation of the first heating module.
